(19) United States
(12) Patent Application Publication
(10) Pub. No.: US 2018/0022286 A1
(43) Pub. Date: Jan. 25, 2018

(54) BICYCLE CARRIER LOCKING ASSEMBLY

(71) Applicant: Thule Sweden AB, Hillerstorp (SE)

(72) Inventor: Joseph SETTELMAYER, McKinleyville, CA (US)

(21) Appl. No.: 15/218,772

(22) Filed: Jul. 25, 2016

(51) Int. Cl. B60R 9/048; E05B 71/00; E05B 79/02; B60R 9/10

(52) U.S. Cl. CPC B60R 9/048; B60R 9/10; E05B 71/00; E05B 79/02

(57) ABSTRACT

A bicycle carrier for mounting on a vehicle is disclosed. The bicycle carrier includes a tray configured to hold a bicycle. The tray defines a conduit. The bicycle carrier also includes a cable partially disposed within the conduit. The cable is configured to extend from and retract into the conduit at a middle portion of a length of the tray. The bicycle carrier also includes a lock head disposed on an end of the cable and a lock housing disposed on the cable and configured to slide along the cable. The lock housing has a through-hole surrounding the cable and a lock hole configured to receive the lock head. The through-hole and the lock hole are parallel to each other.

### FIELD

The present disclosure relates to vehicle-mounted bicycle carriers. More specifically, embodiments of the present disclosure relate to bicycle carriers having a locking assembly configured to secure a bicycle to the bicycle carrier.

### BACKGROUND

Safely and conveniently transporting sports equipment is a concern for many sports enthusiasts. For example, canoes, kayaks, and bicycles can be carried on a vehicle by being attached to one or more carriers. Prevention of theft of the sports equipment is an additional concern for many sports enthusiasts. For example, the sports equipment, such as a bicycle, may be locked to the carrier.

### BRIEF SUMMARY

In some embodiments, a bicycle carrier for mounting on a vehicle may include a tray configured to hold a bicycle, with the tray defining a conduit. In some embodiments, the bicycle carrier may include a cable partially disposed within the conduit. In some embodiments, the cable may be configured to extend from and retract into the conduit at a middle portion of a length of the tray. In some embodiments, the bicycle carrier may include a lock head disposed on an end of the cable. In some embodiments, the bicycle carrier may include a lock housing disposed on the cable and configured to slide along the cable. In some embodiments, the lock housing may have a through-hole surrounding the cable and a lock hole configured to receive the lock head. In some embodiments, the through-hole and the lock hole may be parallel to each other.

In some embodiments, the lock housing may include a key hole on an opposite end of the lock housing from the lock hole configured to receive the lock head. In some embodiments, the key hole and the lock hole are parallel to each other. In some embodiments, the key hole and the lock hole are coaxial. In some embodiments, the middle portion of the length of the tray is disposed closer to a wheel saddle than an end of the tray.

In some embodiments, the bicycle carrier may include a cable passageway housing disposed in the tray that forms an angled passageway leading into the conduit. In some embodiments, the cable passageway housing may include a rivet having a head that is configured to keep the cable passageway housing attached to the tray.

In some embodiments, the tray includes a raised portion and a lower portion. In some embodiments, the conduit may be disposed in the lower portion of the tray. In some embodiments, the raised portion and the lower portion may each be configured to support a bicycle wheel. In some embodiments, the middle portion may be disposed between the raised portion and the lower portion. In some embodiments, the middle portion may be angled.

In some embodiments, the bicycle carrier may include a lock housing anchor disposed in the tray. In some embodiments, the lock housing anchor may be configured to secure the lock housing to the tray. In some embodiments, the lock housing anchor may include a cantilevered arm configured to secure the lock housing within the lock housing anchor. In some embodiments, the cantilevered arm may include a rounded protrusion at a cantilevered end. In some embodiments, the lock housing may include an angled surface configured to push the cantilevered arm down as a user removes the lock housing from the lock housing anchor.

In some embodiments, a bicycle lock may include a lock housing that has a through-hole and a lock hole. In some embodiments, the lock hole may be disposed adjacent to the through-hole. In some embodiments, the bicycle lock may include a cable that has a first end and a second end. In some embodiments, the cable may be partially disposed within the through-hole. In some embodiments, the bicycle lock may include a lock head disposed on the first end of the cable. In some embodiments, the bicycle lock may include a cable passageway housing configured to attach to a bicycle carrier. In some embodiments, the cable passageway housing may have an angled projection that forms an angled passageway. In some embodiments, the cable may be configured to pass through the angled passageway into the bicycle carrier such that the second end of the cable is disposed in the bicycle carrier.

In some embodiments, the lock head is disposed on a side of the lock housing that defines the lock hole. In some embodiments, the through-hole and the lock hole may be parallel to each other. In some embodiments, the lock housing may include a key hole. In some embodiments, the lock housing may be movable relative to the cable.

### BRIEF DESCRIPTION OF THE DRAWINGS

The accompanying drawings, which are incorporated herein and form a part of the specification, illustrate the embodiments and, together with the description, further serve to explain the principles of the embodiments and to enable a person skilled in the relevant art(s) to make and use the embodiments.

FIG. 1 illustrates a perspective view of a bicycle carrier having a locking assembly according to some embodiments.

FIG. 2 illustrates a perspective view of a bicycle secured to the bicycle carrier with a locking assembly according to some embodiments.

FIG. 3 illustrates a close-up view of a locking assembly mounted on a bicycle carrier according to some embodiments.

FIG. 4 illustrates a close-up view of a locking cable extending from a bicycle carrier according to some embodiments.

FIG. 5 illustrates a side, cross-sectional view of a locking cable extending from a bicycle carrier according to some embodiments.

FIG. 6 illustrates a side view of a lock housing of a locking assembly disposed above a lock housing anchor of a bicycle carrier according to some embodiments.

FIG. 7 illustrates a side view of a lock housing of a locking assembly disposed in a lock housing anchor of a bicycle carrier according to some embodiments.

FIG. 8 illustrates a perspective view of a lock housing of a locking assembly disposed above a lock housing anchor of a bicycle carrier according to some embodiments.

FIG. 9 illustrates a close-up view of a bicycle secured to the bicycle carrier with a locking assembly according to some embodiments.

FIG. 10 illustrates a close-up view of a bicycle secured to the bicycle carrier with a locking assembly according to some embodiments.

FIG. 11 illustrates a perspective view of a lock head being inserted into a lock housing of a locking assembly according to some embodiments.

FIG. 12 illustrates a perspective view of a lock head being inserted into a lock housing of a locking assembly according to some embodiments.

FIG. 13 illustrates a perspective view of a lock head being inserted into a lock housing of a locking assembly according to some embodiments.

FIG. 14 illustrates a perspective view of a lock housing mounted in a lock housing anchor on a bicycle carrier according to some embodiments.

FIG. 15 illustrates a side view of a lock housing mounted in a lock housing anchor on a bicycle carrier according to some embodiments.

FIG. 16 illustrates a side view of a lock housing mounted in a lock housing anchor on a bicycle carrier according to some embodiments.

The features and advantages of the embodiments will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Embodiments of the present disclosure are described in detail with reference to embodiments thereof as illustrated in the accompanying drawings. References to “one embodiment,” “an embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following examples are illustrative, but not limiting, of the present embodiments. Other suitable modifications and adaptations of the variety of conditions and parameters normally encountered in the field, and which would be apparent to those skilled in the art, are within the spirit and scope of the disclosure.

Sports equipment, such as bicycles, may be carried on vehicles, for example, by sports equipment carriers (e.g., bicycle carriers). Carriers may include straps and other attachment mechanisms that secure the sports equipment to the carrier to contribute to safe transportation of the sports equipment. To prevent theft, sports enthusiasts may want to lock the sports equipment to the carrier, in addition to attaching it with straps and other attachment mechanisms. However, loose lock cables may flop about on the carrier, which may be noisy and/or cause damage to the carrier, the sports equipment, or the vehicle.

Embodiments of the bicycle carriers 100 disclosed herein may provide a convenient locking assembly that fixes components of the locking assembly to avoid loose lock cables and other components. In some embodiments, bicycle carrier 100 may include a locking cable 210. Cable 210 may be a cable, wire, metal rope, strap, cord, chain, or other similar elongate materials. Cable 210 may be made of metal, aramid fibers (e.g., KEVLAR® available from DuPont), or other strands of material. In some embodiments, cable 210 is stowed within bicycle carrier 100 with a portion extending out of bicycle carrier 100 through a cable passageway housing 220 and ending in a lock head 214. A lock housing 200 is disposed on cable 210 and may be mounted in a lock housing anchor 230 when the locking assembly is not in use. In the mounted position, there may be no loose components.

Furthermore, in some embodiments, when a user desires to utilize the locking assembly, lock housing 200 and lock head 214 are conveniently located in a middle portion of bicycle carrier 100, which is near a portion of the frame of a bicycle 10 that may be suitable for locking (e.g., a portion of the bicycle frame that forms a closed loop). In some embodiments, lock housing 200 may be removed from lock housing anchor 230 and lock head 214 may be pulled to extract a greater portion of cable 210 from bicycle carrier 100. Cable passageway housing 220 may be angled to facilitate easier removal of cable 210 from bicycle carrier 100. In some embodiments, cable 210 is also pulled through a through-hole 202 of lock housing 200. Lock head 214 may be pulled around the bicycle frame and inserted into a lock hole 204 of lock housing 200, thereby locking bicycle 10. Again, in this employed configuration, there may be no loose components. In addition, through-hole 202 and lock hole 204 may be parallel to one another. In this configuration, lock hole 204 is facing in the same direction as a lock head side of through-hole 202 (i.e., generally upwards), which may facilitate easier insertion of lock head 214 into lock hole 204. In some embodiments, a key hole 206 to unlock bicycle 10 is disposed on an opposite end from lock hole 204. This configuration may place key hole 206 conveniently facing downwards to allow a user to more easily unlock bicycle 10.

Embodiments of bicycle carrier 100 can include one or more of the features described herein. While some features may be described in relation to a particular figure, the features can be implemented with other embodiments. Although embodiments described herein focus on bicycle carriers, concepts of embodiments described herein may also be utilized for other sports equipment (e.g., canoes, kayaks, etc.). Moreover, although a particular type of bicycle carrier may be described herein, other types of bicycle carriers 100 may also utilize concepts of embodiments described herein.

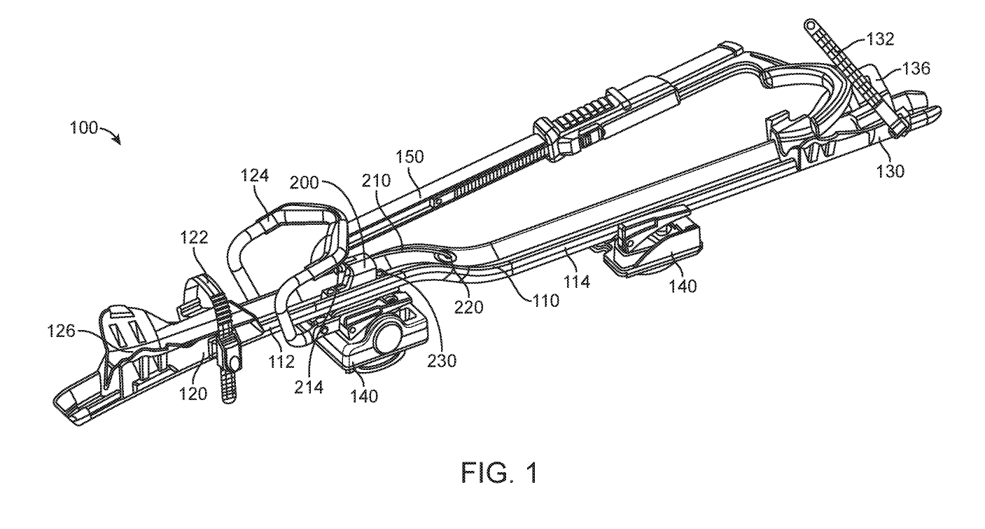

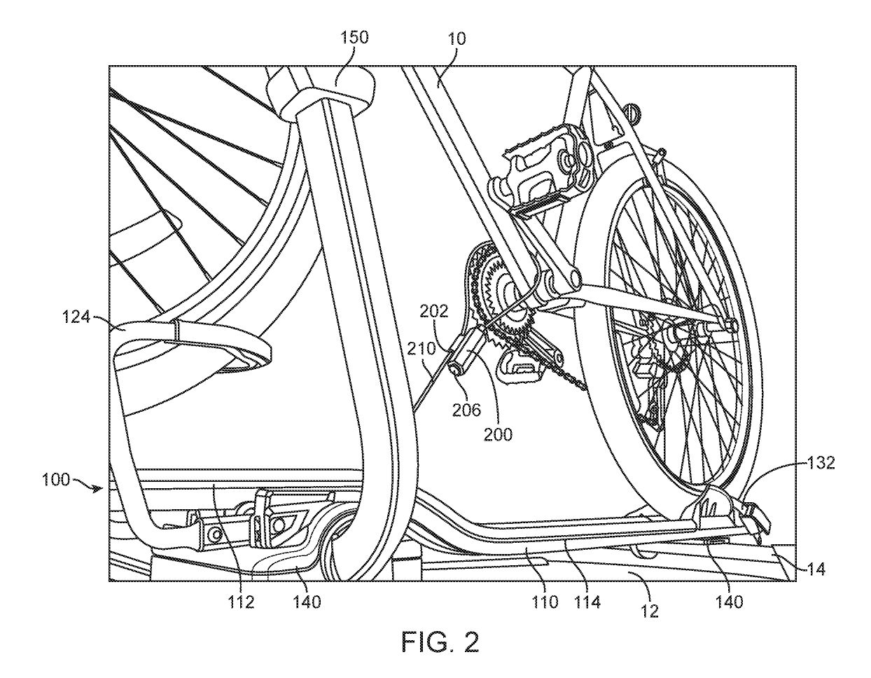

A bicycle carrier 100, as shown, for example, in FIG. 1, may attach to a vehicle and carry a bicycle 10 in a substantially vertical, upright orientation (see FIG. 2). In some embodiments, bicycle carrier 100 includes a bicycle wheel securement. In some embodiments, the bicycle wheel securement may be a bicycle wheel tray 110. Bicycle wheel tray 110 may be long enough to support both wheels of bicycle 10. In some embodiments, bicycle wheel tray 110 includes a raised portion 112 and a lower portion 114. In some embodiments, raised portion 112 and lower portion 114 are each configured to receive a wheel of bicycle 10. For example, raised portion 112 may receive a front wheel of bicycle 10 and lower portion 114 may receive a rear wheel of bicycle 10, or vice versa.

In some embodiments, bicycle wheel tray 110 may include a front wheel securement mechanism 120 and a rear wheel securement mechanism 130. In some embodiments, front wheel securement mechanism 120 may include a securement strap 122. In some embodiments, securement strap 122 can be secured into a ratcheting mechanism, as shown, for example, in FIG. 1. In some embodiments, front wheel securement mechanism 120 may include a wheel support arm 124 configured to secure the front wheel of bicycle 10. In some embodiments, wheel support arm 124 is disposed behind the front wheel of bicycle 10 and configured to provide additional stability to the front wheel of bicycle 10. In some embodiments, front wheel securement mechanism 120 includes a base 126. For example, a wheel, such as a front wheel, may rest on base 126. In some embodiments, base 126 provides a wider structure for the wheel, thus providing additional stability to bicycle 10. In some embodiments, base 126 comprises a wheel saddle for receiving a front or rear wheel of a bicycle, for example.

In some embodiments, rear wheel securement mechanism 130 may include a securement strap 132. In some embodiments, securement strap 132 can be secured into a ratcheting mechanism. In some embodiments, rear wheel securement mechanism 130 includes a base 136. For example, a wheel, such as a rear wheel, may rest on base 136. In some embodiments, base 136 provides a wider structure for the wheel, thus providing additional stability to bicycle 10. In some embodiments, base 136 comprises a wheel saddle.

In some embodiments, bicycle carrier 100 includes a bicycle frame securement 150. In some embodiments, bicycle frame securement 150 may be an adjustable rotatable arm having a substantially U-shaped distal end and configured to secure the frame. In some embodiments, as shown, for example, in FIG. 2, bicycle carrier 100 attaches to a vehicle 12 via vehicle attachment mechanisms 140. For example, vehicle attachment mechanisms 140 may attach to a roof rack 14 of vehicle 12. In this configuration, bicycle carrier 100 may support bicycle 10 in an upright position.

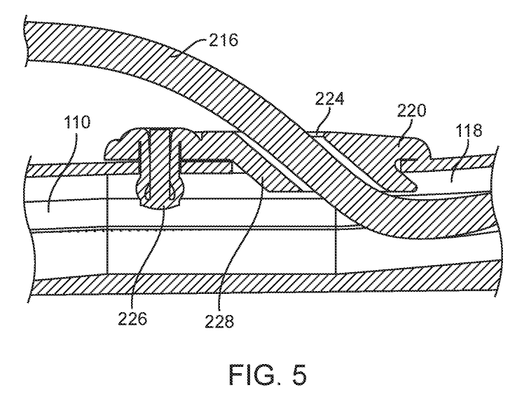

In some embodiments, bicycle carrier 100 includes a locking assembly for locking bicycle 10 to bicycle carrier 100. In some embodiments, the locking assembly is incorporated into bicycle carrier 100. The locking assembly may include lock housing 200, cable 210, cable passageway housing 220, and lock housing anchor 230. In some embodiments, cable 210 extends from bicycle tray 110. Thus, cable 210 may have a first end that is disposed within bicycle carrier 100 and a second end that is disposed at lock housing 200 when lock housing 200 is mounted in lock housing anchor 230. The first end of cable 210 may be disposed in a conduit 118 of bicycle tray 110 (see FIG. 5). In some embodiments, the first end may include a plug to keep cable 210 from entirely exiting conduit 118. Cable 210 may extend through cable passageway housing 220. Because cable 210 is disposed in conduit 118 of bicycle tray 110, bicycle carrier 100 may support and lock a variety of bicycle sizes and styles without the extra length of cable 210 being loose. For example, only that portion of cable 210 needed to surround a portion of the frame of bicycle 10 is removed from conduit 118 with the excess portion of cable 210 remaining stowed within conduit 118. Storing the excess portion of cable 210 within conduit 118 may reduce the amount of loose components on bicycle carrier 100.

The second end of cable 210 may include a lock head 214. In some embodiments, cable 210 extends through a portion of lock housing 200. For example, lock housing 200 may include a through-hole 202. In some embodiments, cable 210 may extend through through-hole 202. In some embodiments, through-hole 202 may slide along cable 210, allowing lock housing 200 to move relative to lock head 214. In some embodiments, lock head 214 prevents lock housing 200 from being completely removed from cable 210.

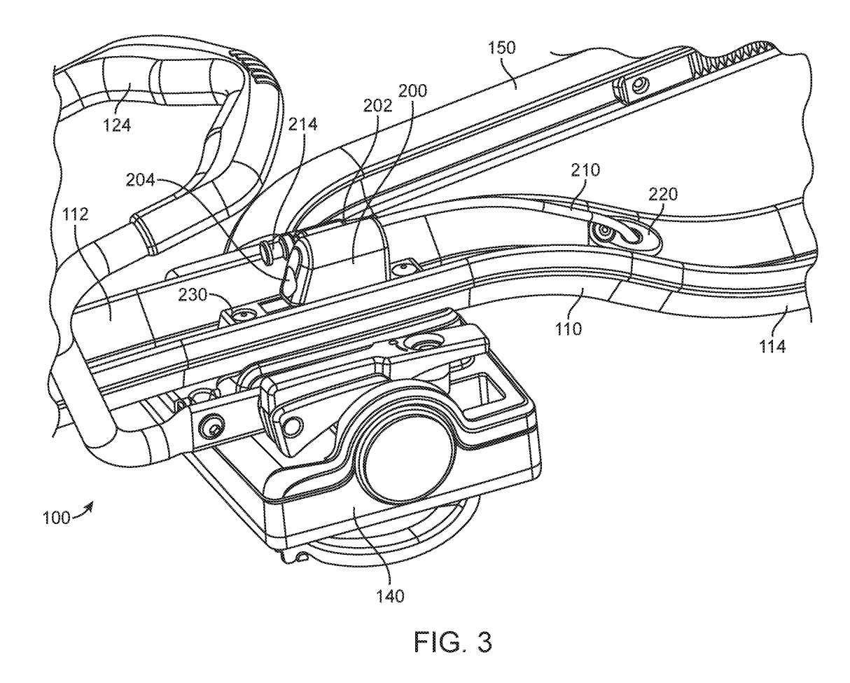

In some embodiments, as shown in FIG. 3, the locking assembly is in a mounted position on bicycle carrier 100. In some embodiments, cable passageway housing 220 and lock housing anchor 230 may be attached to bicycle tray 110. In some embodiments, lock housing anchor 230 may be configured to secure lock housing 200 to bicycle tray 110. In some embodiments, cable passageway housing 220 may provide a passageway for cable 210 to pass into the interior of bicycle tray 110.

In some embodiments, lock housing 200 is slidably coupled with cable 210. In some embodiments, cable 210 passes through through-hole 202 of lock housing 200. In some embodiments, lock housing 200 may be removed from lock housing anchor 230 and cable 210 may be extracted from the interior of bicycle tray 110. In addition, lock housing 200 may slide along cable 210, allowing cable 210 to be pulled through lock housing 200 and around a frame of bicycle 10, as shown, for example, in FIG. 2. In some embodiments, lock housing 200 includes a lock hole 204 configured to receive lock head 214, thereby locking bicycle 10 to bicycle carrier 100.

In some embodiments, cable passageway housing 220 is disposed at a middle portion of bicycle tray 110, as shown, for example, in FIG. 3. This location may lead to greater convenience in locking bicycle 10 to bicycle carrier 100. For example, in general, this location of cable passageway housing 220 places cable 210 close to a frame of bicycle 10, rather than a bicycle wheel. In some embodiments, the middle portion of bicycle tray 110 is disposed between raised portion 112 and lower portion 114, as shown, for example, in FIG. 3. In some embodiments, the middle portion of bicycle tray 110 is angled between raised portion 112 and lower portion 114. In some embodiments, the middle portion is disposed closer to a wheel saddle (e.g., base 136 or base 126) than an end of bicycle tray 110. In some embodiments, cable 210 extends from and retracts into conduit 118 at the middle portion of bicycle tray 110. In some embodiments, cable 210 extends from and retracts into conduit 118 along raised portion 112 of bicycle tray 110. The incline provided by raised portion 112 may facilitate extension and retraction of cable 210 from and into conduit 118. In some embodiments, cable 210 extends from and retracts into conduit 118 at a location that is closer to a wheel saddle than an end of bicycle tray 110. The position of cable passageway housing 220 may facilitate extension and retraction of cable 210 from and into conduit 118.

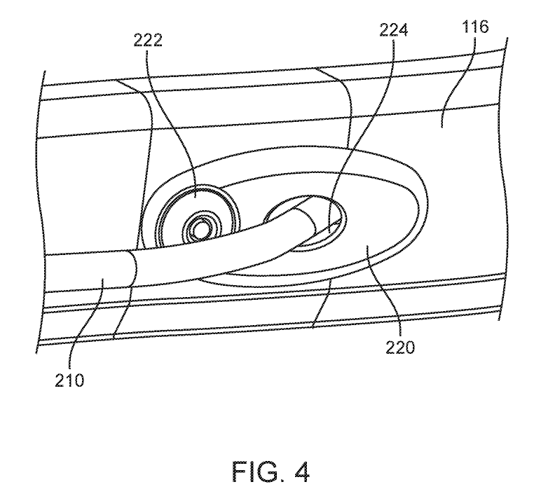

In some embodiments, cable passageway housing 220 may be disposed on a beveled side 116 of bicycle tray 110. For example, as shown in FIG. 4, cable passageway housing 220 may be secured into beveled side 116 of bicycle tray 110 with a fastener 222 (e.g., a rivet). In some embodiments, cable passageway housing 220 creates a passageway 224 for cable 210 to pass into conduit 118 within bicycle tray 110 (see FIG. 5). In some embodiments, an angled projection 228 forms passageway 224 into conduit 118. The angle of angled projection 228 may facilitate extracting cable 210 from conduit 118. In some embodiments, angled projection 228 also contributes to securing cable passageway housing 220 within bicycle tray 110. For example, angled projection 228 may be inserted into bicycle tray 110 and then fastener 222 may be inserted into bicycle tray 110. Both a head 226 of fastener 222 and angled projection 228 together operate to prevent removal of cable passageway housing 220 from bicycle tray 110.

In some embodiments, as shown, for example, in FIG. 3, lock housing anchor 230 is disposed near cable passageway housing 220 in bicycle tray 110. In some embodiments, lock housing anchor 230 is disposed in raised portion 112. In some embodiments, lock housing anchor 230 provides a mount to secure lock housing 200 to bicycle tray 110. In some embodiments, lock housing anchor 230 maintains lock housing 200 mounted in bicycle tray 110 absent an applied force.

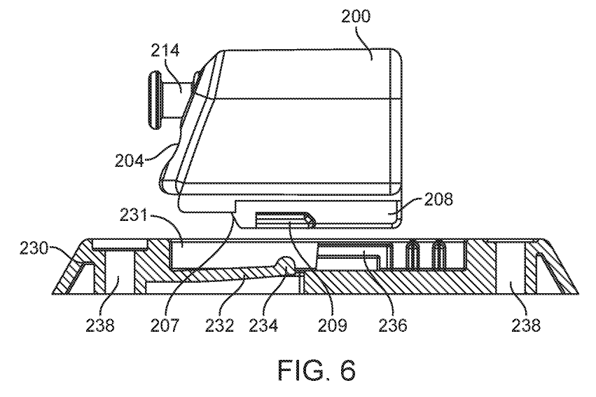

In some embodiments, lock housing anchor 230 is attached to bicycle tray 110 with one or more fasteners 238, as shown, for example, in FIGS. 6-8. In some embodiments, other means of attachment may be used, such as adhesive, welding, etc. In some embodiments, lock housing anchor 230 may define an indent 231 for receiving lock housing 200. In some embodiments, lock housing anchor 230 may include a cantilevered arm 232. Cantilevered arm 232 may be disposed near a bottom of indent 231. In some embodiments, cantilevered arm 232 comprises a rounded protrusion 234 at its cantilevered end. In some embodiments, rounded protrusion 234 may protrude above a bottom surface of indent 231 and restrict movement of lock housing 200 in an X direction. In some embodiments, lock housing anchor 230 may include an interface 236 to receive a portion of lock housing 200 and restrict movement of lock housing 200 in a Z direction. The sides of indent 231 may restrict movement of lock housing 200 in a Y direction.

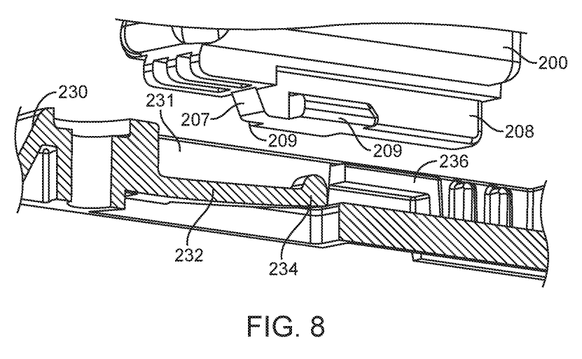

In some embodiments, lock housing 200 includes structure to interface with lock housing anchor 230. For example, lock housing 200 may include a downward projection 208 configured to extend into indent 231 of lock housing anchor 230, as shown, for example, in FIGS. 6-8. In some embodiments, lock housing 200 may include a sideways projection 209 that extends from projection 208. Projection 209 may interact with interface 236 of lock housing anchor 230 to prevent movement of lock housing 200 in a Z direction. In some embodiments, two projections 209 may be included on lock housing 200, with one projection 209 disposed on each side of projection 208 (see FIG. 8).

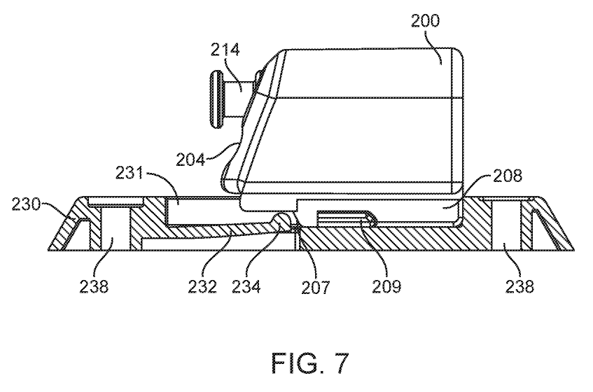

In some embodiments, to secure lock housing 200 within lock housing anchor 230, lock housing 200 may be positioned as shown in FIG. 6. From this location, lock housing 200 may be moved downward into indent 231 of lock housing anchor 230. In some embodiments, the bottom of projection 208 presses down on rounded protrusion 234 of cantilevered arm 232. Because of its cantilevered nature, cantilevered arm 232 moves downward, thus permitting lock housing 200 to be positioned such that projection 209 is disposed below interface 236. In some embodiments, lock housing 200 may be moved horizontally (to the right in FIG. 7) so that projection 209 is positioned directly underneath interface 236. Once lock housing 200 is positioned as shown in FIG. 7, the bottom of projection 208 is no longer pressing down on rounded protrusion 234, allowing cantilevered arm 232 to return to its original position. In this configuration, cantilevered arm 232 is positioned to restrict movement of lock housing 200 in an X direction. For example, projection 208 may be blocked by rounded protrusion 234.

While lock housing anchor 230 keeps lock housing 200 in the mounted position absent applied force, lock housing anchor 230 may be configured to allow a user to remove lock housing 200 from lock housing anchor 230 to lock bicycle 10 to bicycle carrier 100. In some embodiments, a release face 207 is disposed on a front surface of projection 208 to facilitate removal of lock housing 200 from lock housing anchor 230. In some embodiments, release face 207 of projection 208 may be angled, as shown in FIG. 8. In some embodiments, the angled release face 207 of projection 208 allows a user to apply force in a horizontal direction (i.e., to the left in FIG. 7). As the user presses to the left, release face 207 of projection 208 presses down on rounded protrusion 234, thus moving cantilevered arm 232 out of the way of lock housing 200. After lock housing 200 has been moved far enough to the left, projection 209 no longer interacts with interface 236, thus allowing a user to completely remove lock housing 200 from lock housing anchor 230 to lock bicycle 10.

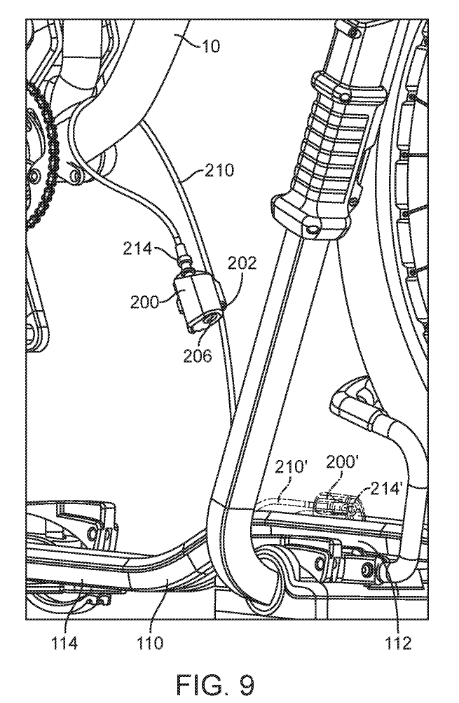

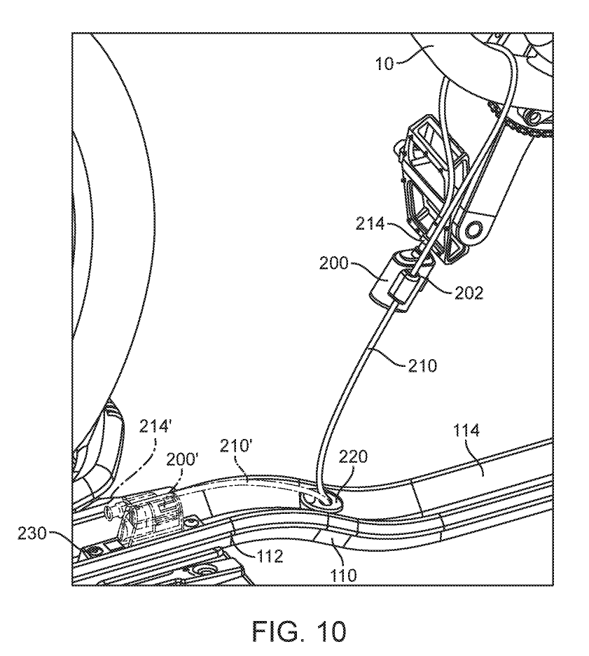

In some embodiments, after lock housing 200 has been removed from lock housing anchor 230, lock housing 200 may be raised and cable 210 extracted from conduit 118 to facilitate locking of bicycle 10, as shown, for example, in FIGS. 9 and 10. In some embodiments, because cable passageway housing 220 is disposed in a middle portion of bicycle tray 110, cable 210 and lock housing 200 are conveniently located such that cable 210 can pass around the frame of bicycle 10 and lock head 214 can be inserted back into lock housing 200. FIGS. 9 and 10 also illustrate lock housing 200′, cable 210′, and lock head 214′ in a mounted configuration.

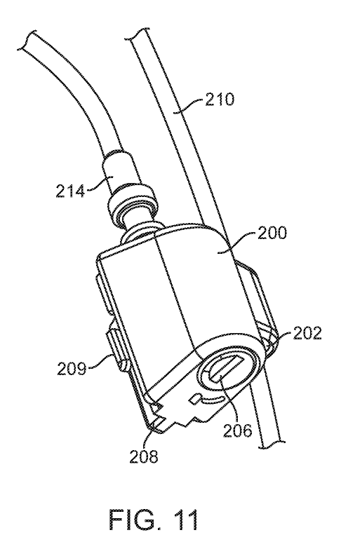

As shown in more detail in FIGS. 11-13, lock housing 200 may include through-hole 202, lock hole 204, and key hole 206. In some embodiments, the locations of through-hole 202, lock hole 204, and key hole 206 facilitate easy locking of bicycle 10 to bicycle carrier 100.

In some embodiments, through-hole 202 is disposed on a side of lock housing 200. In some embodiments, through-hole 202 is disposed on a top of lock housing 200. In some embodiments, through-hole 202 has a length that is less than a length of lock housing 200. For example, through-hole 202 may be three-fourths or half the length of lock housing 200. In some embodiments, through-hole 202 is defined by a side portion of lock housing 200, as shown, for example, in FIGS. 11-13. In some embodiments, through-hole 202 may have a length that is equal to the length of lock housing 200. In some embodiments, through-hole 202 may be part of a main portion of lock housing 200, rather than a side portion (i.e., through-hole 202 has a length that is equal to a length of lock housing 200). In some embodiments, through-hole 202 surrounds cable 210. Lock housing 200 may slide along cable 210 via through-hole 202. In some embodiments, through-hole 202 is smaller in diameter than lock head 214. In some embodiments, lock head 214 cannot pass through through-hole 202. For example, in a mounted position, lock head 214 may be disposed directly adjacent to through-hole 202.

In some embodiments, lock hole 204 is defined by the main body of lock housing 200. In some embodiments, lock hole 204 is disposed adjacent to through-hole 202. In some embodiments, lock hole 204 is parallel to through-hole 202. In some embodiments, lock hole 204 and the side of through-hole 202 from which lock head 214 extends on cable 210 (i.e., the lock head side) may face in the same direction. Because cable 210 extends through through-hole 202 to surround the frame of bicycle 10, lock hole 204 and the lock head side of through-hole 202 may both be facing upwards. Thus, lock hole 204 may be facing in an ideal direction for insertion of lock head 214 into lock hole 204. In some embodiments, lock head 214 is disposed on the same side of lock housing 200 that defines lock hole 204.

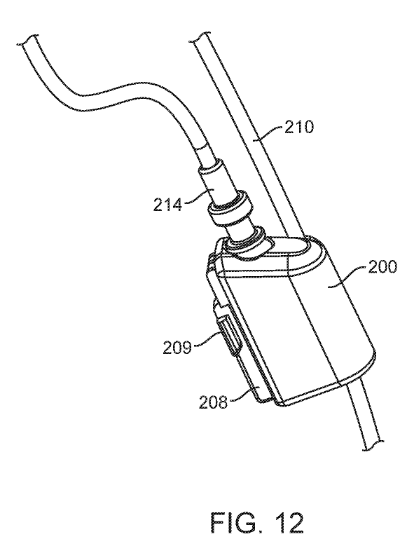

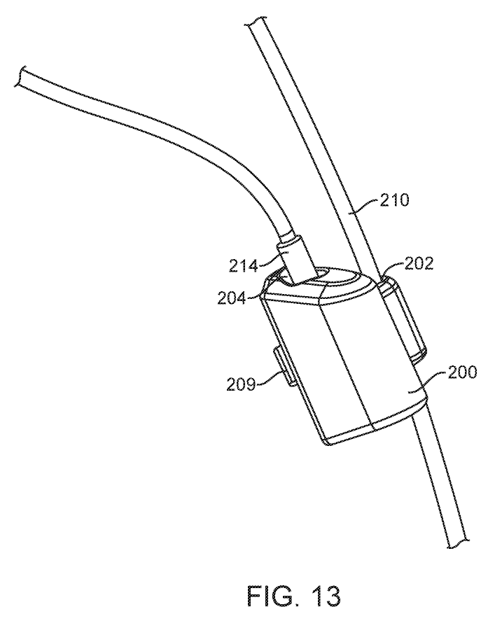

In some embodiments, lock hole 204 is configured to receive lock head 214. For example, FIGS. 11 and 12 illustrate lock head 214 as it is being inserted into lock hole 204. FIG. 13 illustrates lock head 214 when it is already inserted into lock hole 204. In some embodiments, lock head 214 is locked in lock hole 204 when inserted into lock hole 204 to a certain point (e.g., the position in FIG. 13), after which a key may be required to remove lock head 214 from lock hole 204.

In some embodiments, key hole 206 is disposed in the main body of lock housing 200. In some embodiments, key hole 206 is configured to receive a key to unlock lock head 214 so that lock head 214 may be removed from lock hole 204. In some embodiments, key hole 206 is disposed on an opposite end of lock housing 200 than lock hole 204. In some embodiments, key hole 206 faces an opposite direction than lock hole 204 and the lock head side of through-hole 202. In some embodiments, key hole 206 and lock hole 204 are parallel to each other. In some embodiments, key hole 206 and lock hole 204 are co-axial. In some embodiments, while lock hole 204 and the lock head side of through-hole 202 are facing upward, key hole 206 may be facing downward. Thus, key hole 206 may be facing in an ideal direction for a user to insert a key into key hole 206 to unlock bicycle 10.

With through-hole 202, lock hole 204, and key hole 206 configured as described above, locking and unlocking of bicycle 10 is better facilitated. For example, when lock housing 200 is removed from lock housing anchor 230, lock head 214 is disposed on an upper side of lock housing 200, which may facilitate a user easily wrapping lock head 214 and cable 210 around bicycle 10, as shown in FIGS. 9 and 10. Furthermore, lock hole 204 is also disposed on an upper side of lock housing 200, which may facilitate the user easily inserting lock head 214 into lock hole 204. For example, the user does not have to pull lock head 214 around to a different side of lock housing 200 for insertion into lock hole 204, but rather lock hole 204 is disposed on the surface facing the direction from which lock head 214 will come. When the user is ready to unlock bicycle 10, key hole 206 is disposed on a bottom side of lock housing 200, which may facilitate the user easily inserting a key to unlock bicycle 10. For example, the user does not have to reach around to a different side of lock housing 200 for insertion of a key into key hole 206, but rather key hole 206 is disposed on the surface facing the direction from which the user will be reaching with a key.

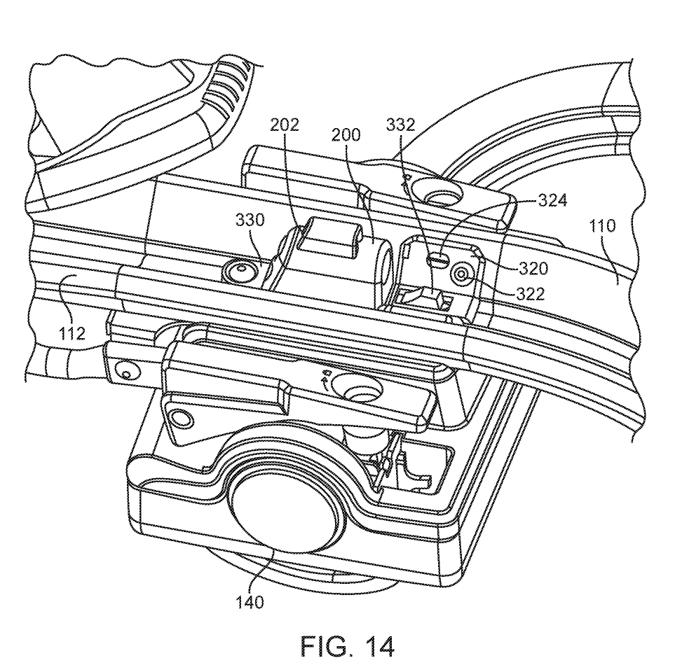

Various components of bicycle carrier 100 and its locking assembly may vary in some embodiments. For example, in some embodiments, bicycle carrier 100 may include cable passageway housing 320 and lock housing anchor 330, as shown, for example, in FIGS. 14-16. In some embodiments, cable passageway housing 320 and lock housing anchor 330 are disposed closer together along bicycle tray 110 than cable passageway housing 220 and lock housing anchor 230. For example, as shown in FIG. 14, cable passageway housing 320 may be disposed directly adjacent to lock housing 200 when lock housing 200 is mounted in lock housing anchor 330. In some embodiments, both cable passageway housing 320 and lock housing anchor 330 are disposed in raised portion 112 of bicycle tray 110. In some embodiments, lock housing anchor 330 and cable passageway housing 320 are part of the same component structurally. In some embodiments, lock housing anchor 330 and cable passageway housing 320 are functionally coupled to one another (e.g., a portion of cable passageway housing 320 operates to help secure lock housing 200 in lock housing anchor 330).

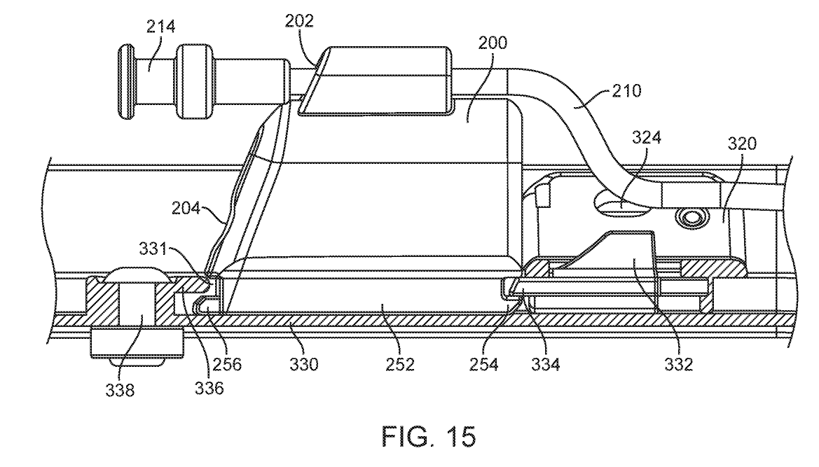

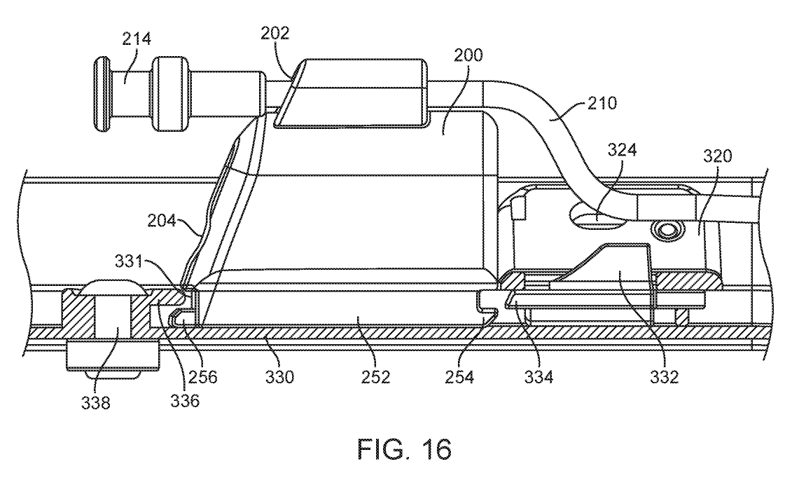

In some embodiments, cable passageway housing 320 includes a fastener 322 and a passageway 324. In some embodiments, fastener 322 is similar to fastener 222 described above. In some embodiments, passageway 324 is similar to passageway 224 described above. In some embodiments, cable passageway housing 320 may also include a switch 332 to help secure lock housing 200 in lock housing anchor 330. For example, switch 332 may be configured to slide between a closed position (see FIG. 15) and an open position (see FIG. 16). In some embodiments, switch 332 is biased to be in the closed position. Upon application of force by a user, switch 332 may be moved to the open position.

In some embodiments, switch 332 includes a lip 334. In some embodiments, lip 334 is configured to interface with a portion of lock housing 200. In some embodiments, lip 334 restricts movement of lock housing 200 in a Z direction, thus securing lock housing 200 within lock housing anchor 330.

In some embodiments, lock housing anchor 330 is attached to bicycle tray 110 with one or more fasteners 338. Fasteners 338 may be similar to fasteners 238. In some embodiments, lock housing anchor 330 may be attached to bicycle tray 110 with other suitable attachment means, such as adhesive, welding, etc. In some embodiments, lock housing anchor 330 may define an indent 331 for receiving lock housing 200. In some embodiments, lock housing anchor 330 includes a lip 336 on one end of indent 331. In some embodiments, lip 336 is configured to interface with a portion of lock housing 200. In some embodiments, lip 336 restricts movement of lock housing 200 in a Z direction, thus securing lock housing 200 within lock housing anchor 330. In some embodiments, lip 334 of switch 332 is disposed on an opposite end of indent 331 from lip 336. The distance between lip 334 and lip 336 when lip 334 is in the closed position (FIG. 15) may be less than a length of a portion of lock housing 200 and greater than a length of another portion of lock housing 200.

In some embodiments, lock housing 200 may comprise different structure to interface with lock housing anchor 330 than the structure to interface with lock housing anchor 230 described above. For example, in some embodiments, lock housing 200 may include a downward projection 252 to extend into indent 331 of lock housing anchor 330, as shown, for example, in FIGS. 15 and 16. In some embodiments, lock housing 200 may include rear projection 254 and front projection 256 that extend from projection 252. In some embodiments, rear projection 254 interacts with lip 334 of switch 332 to restrict movement of lock housing 200 in a Z direction. In some embodiments, front projection 256 interacts with lip 336 to restrict movement of lock housing 200 in a Z direction.

In some embodiments, lock housing 200 may be inserted into lock housing anchor 330 by inserting front projection 256 into indent 331 and underneath lip 336. In some embodiments, the rear portion of lock housing 200 may be pressed down into indent 331. In some embodiments, rear projection 254 may be angled. In some embodiments, lip 334 may be angled, as shown, for example, in FIG. 15. In some embodiments, the angles of rear projection 254 and lip 334 cause switch 332 to move into the open position when lock housing 200 is pressed down. After lock housing 200 is inserted into indent 331 enough for rear projection 254 to be completely underneath lip 334, switch 332 may return to the closed position, thus securing lock housing 200 within lock housing anchor 330.

In some embodiments, once lock housing 200 is disposed within lock housing anchor 330, the application of direct force on lock housing 200 (e.g., pulling up on lock housing 200) may not remove lock housing 200 from lock housing anchor 330. In some embodiments, to remove lock housing 200 from lock housing anchor 330, a user may apply force to switch 332 to move switch 332 into the open position, as shown in FIG. 16. In some embodiments, lock housing 200 may then be removed from lock housing anchor 330 by pulling up on the rear portion of lock housing 200, thus allowing front projection 256 to be angled out from underneath lip 336. Additional variations may be made in various components of bicycle carrier 100 within the scope of the present disclosure.

It is to be appreciated that the Detailed Description section, and not the Brief Summary and Abstract sections, is intended to be used to interpret the claims. The Summary and Abstract sections may set forth one or more but not all exemplary embodiments of watercraft carriers as contemplated by the inventors, and thus, are not intended to limit the present embodiments and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. A bicycle carrier for mounting on a vehicle, the bicycle carrier comprising:
a tray configured to hold a bicycle, the tray defining a conduit;
a cable partially disposed within the conduit, wherein the cable is configured to extend from and retract into the conduit at a middle portion of a length of the tray;
a lock head disposed on an end of the cable; and
a lock housing disposed on the cable and configured to slide along the cable, the lock housing having a through-hole surrounding the cable and a lock hole configured to receive the lock head,
wherein the through-hole and the lock hole are parallel to each other.

2. The bicycle carrier of claim 1, wherein the lock housing comprises a key hole on an opposite end of the lock housing from the lock hole configured to receive the lock head.

3. The bicycle carrier of claim 2, wherein the key hole and the lock hole are parallel to each other.

4. The bicycle carrier of claim 2, wherein the key hole and the lock hole are coaxial.

5. The bicycle carrier of claim 1, wherein the middle portion of the length of the tray is disposed closer to a wheel saddle than an end of the tray.

6. The bicycle carrier of claim 1, further comprising a cable passageway housing disposed in the tray that forms an angled passageway leading into the conduit.

7. The bicycle carrier of claim 6, wherein the cable passageway housing comprises a rivet having a head configured to keep the cable passageway housing attached to the tray.

8. The bicycle carrier of claim 1, wherein the tray comprises a raised portion and a lower portion.

9. The bicycle carrier of claim 8, wherein the conduit is disposed in the lower portion of the tray.

10. The bicycle carrier of claim 8, wherein the raised portion and the lower portion are each configured to support a bicycle wheel.

11. The bicycle carrier of claim 8, wherein the middle portion is disposed between the raised portion and the lower portion, and wherein the middle portion is angled.

12. The bicycle carrier of claim 1, further comprising a lock housing anchor disposed in the tray, wherein the lock housing anchor is configured to secure the lock housing to the tray.

13. The bicycle carrier of claim 12, wherein the lock housing anchor comprises a cantilevered arm configured to secure the lock housing within the lock housing anchor.

14. The bicycle carrier of claim 13, wherein the cantilevered arm comprises a rounded protrusion at a cantilevered end.

15. The bicycle carrier of claim 12, wherein the lock housing comprises an angled surface configured to push the cantilevered arm down as a user removes the lock housing from the lock housing anchor.

16. A bicycle lock comprising:
a lock housing having a through-hole and a lock hole, the lock hole disposed adjacent to the through-hole;
a cable having a first end and a second end, the cable partially disposed within the through-hole;
a lock head disposed on the first end of the cable;
a cable passageway housing configured to attach to a bicycle carrier, the cable passageway housing having an angled projection that forms an angled passageway,
wherein the cable is configured to pass through the angled passageway into the bicycle carrier such that the second end of the cable is disposed in the bicycle carrier

17. The bicycle carrier of claim 1, wherein the lock head is disposed on a side of the lock housing that defines the lock hole.

18. The bicycle lock of claim 16, wherein the through-hole and the lock hole are parallel to each other.

19. The bicycle lock of claim 16, the lock housing further comprising a key hole.

20. The bicycle lock of claim 16, wherein the lock housing is movable relative to the cable.
